(19) United States
(12) Patent Application Publication
(10) Pub. No.: US 2009/0054270 A1
(43) Pub. Date: Feb. 26, 2009

(54) HYDROCOLLOID GUM COMPOSITIONS, METHODS OF FORMING THE SAME, AND PRODUCTS FORMED THEREFROM

(75) Inventors: Denise L. Williams, Oreana, IL (US); Michael L. Rambo, Argenta, IL (US); Peter J. Olney, Oreana, IL (US); Neil W. Camp, Monticello, IL (US); Bruce R. Sebree, Oakley, IL (US)

Correspondence Address: K&L GATES LLP;HENRY W. OLIVER BUILDING, 535 SMITHFIELD STREET, PITTSBURGH, PA, 15222, US

(73) Assignee: Archer-Daniels-Midalnd Company, Decatur, IL (US)

(21) Appl. No.: 12/194,986

(22) Filed: Aug. 20, 2008

Related U.S. Application Data
(60) Provisional application No. 60/957,085, filed on Aug. 21, 2007.

(51) Int. Cl. C09K 8/10

(52) U.S. Cl. 507/114; 507/112

(57) ABSTRACT

Hydrocolloid gum compositions, methods of forming the same, and products formed therefrom. The composition may comprise a hydrocolloid gum, such as xanthan gum, a cellulose thickener, and a solvent component. The solvent component may comprise a lactate ester and, optionally, an alkylene glycol alkyl ether.

### CROSS REFERENCE TO RELATED APPLICATIONS

The application claims the priority of U.S. Provisional Patent Application No. 60/957,085, filed Aug. 21, 2007, the disclosure of the entirety of which is incorporated by this reference.

### TECHNICAL FIELD

The present disclosure relates to hydrocolloid gum compositions, methods of forming the same, and products formed therefrom.

### BACKGROUND

Hydrocolloid gums are substances that, when dispersed in water, yield a colloid system that can take on different states, such as a gel. Various types of hydrocolloid gums include, for example, xanthan gum, guar gum, and the like. Xanthan gum is a high molecular weight, naturally occurring polysaccharide that may be produced by the fermentation of glucose or sucrose by bacteria of the genus Xanthomonas, preferably X. campestris. Xanthan gum can be used as a thickener to impart thixotropic properties to aqueous compositions for applications in food, pharmaceutical, and chemical industries. When incorporated into water, however, xanthan gum molecules have a stiff, rod-like structure. Thus, rather than building viscosity by polymer chain entanglement and/or hydrophobic associations, xanthan gum is generally believed to build viscosity in aqueous compositions by the formation of a three-dimensional network of xanthan gum molecules held together by hydrogen bonds. Because this network structure can rapidly be broken down by the application of an external shear force to the structure, compositions thickened by xanthan gum are highly shear-thinning. Furthermore, because the viscosity-building network structure of hydrated xanthan gum is rapidly re-established when the external shear force is removed, compositions thickened with xanthan gum tend to regain viscosity more rapidly than compositions thickened with other viscosity-builders.

Due to the rapid hydration of unmodified xanthan gum in water, direct incorporation of unmodified xanthan gum into aqueous compositions can be difficult. For example, directly adding unmodified xanthan gum powder to an aqueous composition can result in an extremely rapid increase in the viscosity of the aqueous composition and the formation of a gel containing agglomerates or lumps of unhydrated xanthan gum. Such gel formation is generally undesirable as it can make both mixing of the composition and incorporation of other components into the composition difficult. Thus, attempts to add xanthan gum powders directly to aqueous compositions have generally involved use of specialized mixing procedures or equipment such as high-shear mixers, or xanthan gum powders that have been encapsulated or surface-modified with another substance to retard hydration.

Although it is possible to pre-mix xanthan gum thickeners with some alkylene glycol alkyl ether solvents, such as dipropylene glycol methyl ether, prior to the addition of the thickener to the aqueous composition, the use of alkylene glycol alkyl ether solvents is costly. Additionally, because of their high volatile organic compound (VOC) content, alkylene glycol alkyl ether solvents (i.e. dialkylene glycol alkyl ether solvents) can have a negative impact on the environment.

Furthermore, because many hydrocolloid gums, such as xanthan gum, are bioderived substances, substitution of hydrocolloid-based rheological agents for petroleum-based agents allows for the production of a biobased drilling fluid. In an effort to diminish dependence on petroleum products the United States government enacted the Farm Security and Rural Investment Act of 2002, section 9002 (7 U.S.C. 8102), hereinafter “FSRIA,” which requires federal agencies to purchase biobased products, if available, for all items costing over $10,000. In response, the United States Department of Agriculture (“USDA”) has developed Guidelines for Designating Biobased Products for Federal Procurement (7 C.F.R. §2902) to implement FSRIA, including the labeling of biobased products with a “USDA Certified Biobased Product” label.

FSRIA has established certification requirements for determining biobased content. These methods require the measurement of variations in isotopic abundance between biobased products and petroleum derived products, for example, by liquid scintillation counting, accelerator mass spectrometry, or high precision isotope ratio mass spectrometry. Isotopic ratios of the isotopes of carbon, such as the ¹³C/¹²C carbon isotopic ratio or the ¹⁴C/¹²C carbon isotopic ratio, can be determined using analytical methods, such as isotope ratio mass spectrometry, with a high degree of precision. Studies have shown that isotopic fractionation due to physiological processes, such as, for example, CO₂ transport within plants during photosynthesis, leads to specific isotopic ratios in natural or bioderived compounds. Petroleum and petroleum derived products have a different ¹³C/¹²C carbon isotopic ratio due to different chemical processes and isotopic fractionation during the generation of petroleum. In addition, radioactive decay of the unstable ¹⁴C carbon radioisotope leads to different isotope ratios in biobased products compared to petroleum products. Biobased content of a product may be verified by ASTM International Radioisotope Standard Method D 6866. ASTM International Radioisotope Standard Method D 6866 determines biobased content of a material based on the amount of biobased carbon in the material or product as a percent of the weight (mass) of the total organic carbon in the material or product. Both bioderived and biobased products will have a carbon isotope ratio characteristic of a biologically derived composition.

Thus, there is a need for safe, environmentally friendly compositions containing hydrocolloid gums, such as xanthan gum, and related formation methods wherein the hydrocolloid gums can be hydrated without the agglomerates to produce products in the food, pharmaceutical, chemical, and petroleum industries.

### BRIEF SUMMARY

Disclosed herein are various non-limiting embodiments generally related to compositions comprising hydrocolloid gums, including, but not limited to, xanthan gum, that can be used, for example, as drilling compositions or as thickening agents in thickening systems, and methods of forming the same.

In one embodiment, the present disclosure provides a composition comprising a hydrocolloid gum, a cellulose thickener, and a solvent component comprising a lactate ester and, optionally, an alkylene glycol alkyl ether.

In another embodiment, the present disclosure provides a thickening system comprising a hydrocolloid gum, a cellulose thickener, and a solvent component. The solvent may comprise a lactate ester and, optionally, an alkylene glycol alkyl ether.

In another embodiment, a method of forming a slurry composition is disclosed. The method comprises adding a cellulose thickner to a solvent component to form a mixture. The mixture is mixed until the cellulose thickner is viscosified the solvent. One or more additives may be added to the mixture. Xanthum gum is added to the mixture to form the composition or slurry. The solvent component may comprise a lactate ester and, optionally, an alkylene glycol alkyl ether.

The present disclosure also provides a drilling fluid comprising a hydrocolloid gum, a cellulose thickener, and a solvent component. The solvent component may comprise a lactate ester and, optionally, an alkylene glycol alkyl ether. The drilling fluid may be 100% biobased as determined by ASTM International Radioisotope Standard Method D 6866.

It should be understood that this invention is not limited to the embodiments disclosed in this Summary, and it is intended to cover modifications that are within the spirit and scope of the invention, as defined by the claims.

### DETAILED DESCRIPTION

Other than in the operating examples, or unless otherwise expressly specified, all of the numerical ranges, amounts, values and percentages, such as those denoting amounts of materials, times and temperatures of reaction, ratios of amounts, and others in the following portion of the specification, may be read as if prefaced by the word “about,” even though the term “about” may not expressly appear with the value, amount or range. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

Notwithstanding the fact that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. In addition, the terms “one,” “a,” or “an” as used herein are intended to include “at least one” or “one or more,” unless otherwise indicated.

Any patent, publication, or other disclosure material, in whole or in part, that is identified herein is incorporated by reference herein in its entirety, but is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present disclosure provides various features and aspects of the exemplary embodiments provided herein. It is understood, however, that the present disclosure embraces numerous alternative embodiments, which may be accomplished by combining any of the different features, aspects, and embodiments described herein in any combination that one of ordinary skill in the art may find useful.

As previously discussed, various non-limiting embodiments of the present disclosure are directed to compositions, such as, for example, slurries for use as drilling fluids or in thickening systems, comprising a hydrocolloid gum, a cellulose thickener, and a solvent component, such as a solvent blend. As used herein, the term “thickening system” includes compositions that employ Theological thickening agents, such as hydrocolloid thickeners, as an additive therein, and includes, for example, aqueous solutions and food products. The term “slurry,” as used herein, includes a suspension of insoluble particles in a liquid medium. As used herein, the term “mixture” includes any combination of at least two components and includes, for example, blends, dispersions, solutions, emulsions, suspensions, and combinations of any thereof. Furthermore, the term “solvent blend,” as used herein, includes a mixture of two or more solvents.

Various hydrocolloid gums may be employed in compositions of the present disclosure, such as, for example, xanthan gum, guar gum, gellan gum, locust bean gum, gum Arabic, alginates, and combinations of any thereof. Generally, the hydrocolloid gum may be present in embodiments of the present disclosure in any effective amount and, in certain embodiments, may be present in amounts ranging from 1% to 45% by weight.

In certain embodiments, the hydrocolloid gum may be xanthan gum. As used herein, “xanthan gum” includes a high molecular weight, naturally occurring polysaccharide containing D-glucose, D-mannose, and D-glucaronic acid produced by bacterial fermentation of glucose or sucrose by bacteria of the genus Xanthomonas. Four species of Xanthomonas, X. campestris, X. phaseoli, X. malvocearum, X. carotal are considered the most efficient producers of gum. Xanthan gum can be used as a thickener to impart thixotropic properties to aqueous compositions.

When employed in certain embodiments of the present disclosure, the xanthan gum may be, for example, a modified xanthan gum, an unmodified xanthan gum, or mixtures of any thereof. Xanthan gums that are suitable for use in conjunction with various non-limiting embodiments disclosed herein include, but are not limited to, unmodified xanthan gums. When employed, xanthan gum may be present in compositions comprising the cellulose thickener and solvent blend of the present disclosure in any effective amount, and in certain embodiments may be present in an amount ranging from 1% to 45% by weight. The amount of xanthan gum present in the composition may vary depending on the desired viscosity of the final slurry product. For example, the viscosity range of the slurry with 42% by weight of xanthan gum is 25,000 to 45,000 centipoise (Brookfield viscometer, 23° C., 3 rpm). A slurry product containing less xanthan gum will have a lower viscosity range and a slurry product with more xanthan gum will have a higher viscosity range.

The hydrocolloid gum particles may have various average particle sizes (mesh), such as, for example, 80/120, 120/200, or 80/200. In some embodiments, the particle size may be 80 to 170 mesh (or 90 to 130 microns). The average particle size can be measured according to known techniques. For example, the average particle size of such particles is measured using a Laser Diffraction Particle Size Analyzer (Beckman Coulter) particle size instrument to measure the size of the particles and assumes the particle has a spherical shape, i.e., the “particle size” refers to the smallest sphere that will completely enclose the particle. Particle size may also be measured by USA Standard Sieve Method ASTME-II specification.

In embodiments of the present disclosure, compositions may also include a cellulose thickener. As used herein a “cellulose thickener” includes a natural carbohydrate high polymer (polysaccharide) having anhydroglucose units joined by an oxygen linkage to form long molecular chains that are essentially linear and may be used to increase the density or viscosity of the composition to which it is added. Various cellulose thickeners may be employed in compositions of the present disclosure such as, but is not limited to, hydroxypropyl cellulose, hydroxyethyl cellulose, hydroxypropylmethyl cellulose, ethyl hydroxyethyl cellulose, methyl ethyl hydroxyethyl cellulose, hydroxymethyl cellulose, hydroxyethylmethyl cellulose, carboxymethyl cellulose, sodium carboxymethyl cellulose, microcrystalline cellulose, and combinations of any thereof. In certain embodiments, the cellulose thickeners may be added to compositions, such as xanthan slurry suspensions, of the present disclosure in any amount sufficient to achieve desired rheological properties. For example, in certain embodiments, the cellulose thickeners may be combined with the gum and solvent blend components in amounts ranging from 0.5 to 1.0% by weight, and in other embodiments in amounts ranging from 0.1 to 2.0% by weight. The amounts of cellulose thickener present in the composition may vary depending on the desired rheological properties desired. For example, the viscosity range of the cellulose thickener at a concentration of 1% in water may be 1500 to 3000 centipoise (Brookfield viscometer, 23° C., 3 rpm).

In embodiments of the present disclosure, compositions provided herein also include a solvent component. As discussed herein, due to the rapid hydration of hydrocolloid gums, such as, for example, unmodified xanthan gum in water, direct incorporation of hydrocolloid gums into aqueous compositions can be difficult. For example, directly adding unmodified xanthan gum powder to an aqueous composition can result in an extremely rapid increase in the viscosity of the aqueous composition and the formation of a gel containing agglomerates or lumps of unhydrated xanthan gum. Such gel formation is generally undesirable as it can make both mixing of the composition and incorporation of other components into the composition difficult. Conventional formation methods have attempted to address this problem by pre-mixing, for example, xanthan gum thickeners with alkylene glycol alkyl ethers (i.e. dipropylene glycol alkyl ether), prior to the addition of the thickener to aqueous compositions. However, the use of alkylene glycol alkyl ether solvents is costly. In addition, because of the high volatile organic compound (VOC) content, alkylene glycol alkyl ether solvents (i.e. dialkylene glycol alkyl ether solvents) can have a negative impact on the environment, and their use has been discouraged.

It has now been discovered that by replacing at least a portion, and in some embodiments, all or substantially all, of the alkylene glycol alkyl ether solvent used in conventional compositions with lactate esters, suitable compositions, such as slurry suspensions, comprising hydrocolloid gum may be formed. Replacement of alkylene glycol alkyl ether solvent with lactate esters may be complete or partial and in various effective amounts ranging from, for example, 1% to 100% by weight, and in certain embodiments ranging from 25% to 50% by weight. In this manner, compositions may be formed that are suitable for use, for example, as slurry suspensions employed as drilling fluids, and for incorporation into, for example, aqueous solutions as a thickening agent, without the economic cost and/or environmental impact of conventional compositions that use relatively larger quantities of alkylene glycol alkyl ether solvents (i.e dialkylene glycol alkyl ether).

In various embodiments, the compositions of the present invention may be used in the following non-limiting applications: horizontal drilling and completions; drill-in fluids; drilling large diameter well bores; solids-free drilling, completion and workover; coring fluids; gravel-packing operations; coiled tubing friction reducer; and as an acid thickener. In other embodiments, the compositions of the present invention may be used as a thickener in drilling fluids and function to cool and clean a drill bit used in drilling; provide up hole velocity for drill cuttings to get the cuttings out of the hole; keep an annular bore hole space clean to prevent friction and clogging; and balance hydraulic pressures exerted by the earth on the bore hole.

In one embodiment, a composition of the present invention may be used as a drilling fluid. In this embodiment, a liquid composition of the present invention is dispersed in water, such as by combining a metered amount of the liquid composition with a metered amount of water to achieve a desired viscosity, thus producing a drilling mud. The drilling mud is pumped into a bore hole through an inner portion of a drill pipe with an increased velocity and shear such that the drilling mud passes through orifices or “jets” in a drill bit located at the end of the drill pipe. In this manner, the drilling mud may function to cool and lubricate the drill bit, while also functioning to remove cuttings made by the drill bit made by the drilling action of the bit. The drilling mud functions to carry the cuttings and other solids, if present, to the well surface through the “annulus,” the whole outside the drill pipe, made by the drill bit. In carrying the cuttings and other solids, the drilling mud has a relatively high viscosity such that during drilling and interruption periods, the viscosity of the drilling mud located in the annulus prevents any cuttings and other solids from slipping back down the hole or “sinking” back into the lower portions of the drill hole. In one embodiment, the drilling mud has a low viscosity under high shear as it is being pumped down the inner portion of the drill pipe, and an increased viscosity under lower shear as the drilling mud is rising up the annulus and back to the surface of the well such that is causes the cuttings and/or other solids to “float” up the annulus.

In another embodiment, the drilling fluid or mud of the present invention may comprise other compounds used in drilling fluids including, but not limited to, barium sulfate (barite), calcium carbonate (chalk), hematite, guar gum, glycol, carboxymethylcellulose, polyanionic cellulose, starch, a lubricant, or combinations of any thereof.

For example, in certain embodiments, the solvent component may be a solvent blend comprising an alkylene glycol alkyl ether and a lactate ester. Due to similarities in chemical structure, suitable alkylene glycol alkyl ethers that may be employed in embodiments of the present disclosure include, but are not limited to, those alkylene glycol alkyl ethers set forth in Table 1, and any combination thereof.

TABLE 1
Alkylene glycol alkyl ether solvents

| Common Name | Abbreviation | Chemical Name |
|---|---|---|
| Ethylene glycol monomethyl ether | EGME | 2-methoxyethanol |
| Ethylene glycol monomethyl ether acetate | EGMEA | 2-methoxyethyl acetate |
| Ethylene glycol monoethyl ether | EGEE | 2-ethoxyethanol |
| Ethylene glycol monoethyl ether acetate | EGEEA | 2-ethoxyethyl acetate |
| Ethylene glycol monopropyl ether | EGPE | 2-propoxyethanol |
| Ethylene glycol monobutyl ether | EGBE | 2-butoxyethanol |
| Ethylene glycol dimethyl ether | EGDME | 1,2-dimethoxyethane |
| Ethylene glycol diethyl ether | EGDEE | 1,2-diethoxyethane |
| Diethylene glycol | DEG | |
| Diethylene glycol monomethyl ether | DEGME | 2-(2-methoxyethoxy)ethanol |
| Diethylene glycol monoethyl ether | DEGEE | 2-(2-ethoxyethoxy)ethanol |
| Diethylene glycol monobutyl ether | DEGBE | 2-(2-butoxyethoxy)ethanol |
| Diethylene glycol dimethyl ether | DEGDME | bis(2-methoxyethyl)ether |
| Diethylene glycol propyl ether | | |
| Triethylene glycol dimethyl ether | TEGDME | |
| Propylene glycol monomethyl ether | PGME | 1-methoxy-2-propanol |
| Prolylene glycol monomethyl ether acetate | PGMEA | |
| Dipropylene glycol | DPG | |
| Dipropylene glycol monomethyl ether | DPGME | |

Suitable lactate esters include, but are not limited to, ethyl lactate, methyl lactate, butyl lactate and combinations of any thereof. In certain embodiments, the solvent blend may be a blend of dipropylene glycol methyl ether and ethyl lactate. For example, in one embodiment, the solvent blend may comprise from 0% to 95% by weight dipropylene glycol methyl ether and from 1% to 100% by weight ethyl lactate. In other embodiments, the solvent blend may be a blend of diethylene glycol propyl ether and ethyl lactate. For example, in one embodiment, the solvent blend may comprise from 0% to 95% by weight diethylene glycol propyl ether and from 1% to 100% by weight ethyl lactate. In addition, the solvent blend may be prepared in order to obtain various solvent characteristics, such as a desired flashpoint. For example, in certain embodiments, the solvent blend may comprise 5% to 50% by weight ethyl lactate and have a flash point equal to or greater than 140° F. Actual flash point of a slurry with 50/50 solvent blend of dipropylene glycol methyl ether and ethyl lactate was 240 to 260° F. and a slurry with 100% ethyl lactate had a flash point of 220 to 230° F. Flash point tests were performed by ASTM Method D93. Accordingly, compositions of the present disclosure that include various hydrocolloid gums, including xanthan gum, may be formed having smaller quantities of alkylene glycol alkyl ether solvents than what has been employed in the prior art. The solvents employed have reduced volatile organic compounds, some embodiments may be essentially free of volatile organic compounds, and other embodiments are free of volatile organic compounds. As used herein, the term “essentially free of volatile organic compounds” means less than 10 grams of VOC per liter of material tested according to EPA Reference Method 24. EPA Reference Method 24 is found at 40 C.F.R. §60, Appendix A, which is incorporated by reference herein in its entirety. As used herein, the term “free of volatile organic compounds” means the amount of VOC measured using EPA Reference Method 24 is within the standard error of the test method and therefore statistically insignificant. The error for EPA Reference Method 24 is described in the article by Mania et al. in the August 2001 issue of The Journal of Coatings Technology, which is incorporated by reference herein in its entirety. Substituting ethyl lactate for other solvents would decrease VOC. Furthermore, the lower VOCs may pertain to a whole or partial addition of ethyl lactate in the product.

In certain embodiments, additives may be present in compositions of the present disclosure in order to provide certain benefits to the compositions set forth herein. When present, appropriate additives include, but are not limited to, one or more of a surfactant, a dispersant, a pH modifier, a defoamer, a biocide, a humectant, a colorant, a pigment, and mixtures of any thereof. Examples of suitable surfactant materials may include, but are not limited to, sorbitan monolaurate, sorbitan monostearate, sorbitan monopalmitate, sorbitan monooleate, sorbitan tristearate, sorbitan trioleate, polyoxyethylene sorbitan monolaurate, polyoxyethylene sorbitan monopalmitate, polyoxyethylene sorbitan monostearate, polyoxyethylene sorbitan monooleate, polyoxyethylene sorbitan tristearate, polyoxyethylene sorbitan trioleate, sodium stearate, sodium laurate, sodium palmitate, sodium myrisate, sodium oleate, potassium laurate, potassium stearate, potassium oleate, polyethylene glycol monolaurate, polyethylene glycol monostearate, polypropylene glycol monolaurate, polyethylene glycol monobutyl ether, polyethylene glycol monomethyl ether, sucrose monolaurate, combinations of any thereof and other similar materials. One of ordinary skill in the art may contemplate additional additives desirable for incorporation in compositions provided in the present disclosure. The additives may be employed in various amounts to achieve certain desired properties or benefits. For example, in one embodiment, the additives may be present in the compositions of the present disclosure in amounts ranging from 0 to 1% by weight.

The hydrocolloid component, the cellulose thickener, the solvent component, and the optional additives, as described herein, may be combined in any suitable manner to form the mixtures of the present disclosure. As provided in the Examples set forth herein, in certain embodiments, the hydrocolloid compositions or slurry may be formed by adding the cellulose thickener to a solvent component to form a mixture. The mixture may be mixed until the cellulose thickener has fully viscosified the solvent. One or more additives may be combined with the mixture. The xanthan gum may be added to the composition or slurry.

Conventional xanthan slurries typically used as thickeners in aqueous solutions are prepared using alkylene glycol alkyl ether-based solvents (i.e. dialkylene glycol alkyl ether). The use of such alkylene glycol alkyl ether-based solvents is undesirable because of their relatively high cost and high VOC content. The present disclosure provides compositions that replace a portion of, substantially all, or all of the alkylene glycol alkyl ether with lactate esters including, but not limited to ethyl lactate, methyl lactate, butyl lactate or combinations of any thereof.

In certain embodiments, thickening systems employing the compositions set forth herein, are disclosed. Such systems are ideal for increasing the viscosity of, for example, aqueous solutions. The thickening system of the present disclosure may comprise the hydrocolloid gums, cellulose thickeners, and solvent components described herein. The thickening system may be, for example, a xanthan gum thickening system that may be mixed with a cellulose thickener and a solvent blend, such as alkylene glycol alkyl ether and a lactate ester.

Compositions, such as thickening systems, disclosed herein may be exposed to high temperatures, pressures, and shear force. In these situations, compositions of the present disclosure may be prepared to exhibit certain properties, including, for example, a desired flash point. In certain embodiments, for example, the present disclosure provides a hydrocolloid composition, such as a xanthan slurry, that may comprise from 5% to 50% ethyl lactate and in another embodiment, have a flash point of at least 140° F. or higher.

In certain embodiments, the present disclosure provides compositions wherein the dispersion of the hydrocolloid particles exhibits minimal settling. In certain embodiments, less than 1% by weight of hydrocolloid, such as xanthan particles settles or precipitates out of solution incorporating the compositions of the present disclosure within a 12 month period, measured from the date of manufacture of the slurry. The slurry suspensions may be prepared for drilling fluids or for incorporation into a composition, such as aqueous thickening systems. Thus, the final slurry may be stored for a period of time or may be shipped from a manufacturing facility to the site of use.

In certain embodiments, compositions of the present disclosure may be packaged and shipped from one location to another in various forms such as, for example, as a slurry for use as a drilling fluid or as a thickening agent for thickening systems, for direct use or further processing. The shipment of the compositions may be, for example, by air, by railcar, by ship, by truck, or combinations or any thereof.

Compositions provided herein may be mixtures that take various forms, such as slurries, and may be used alone or incorporated into products having various uses. For example, compositions of the present disclosure may be used as emulsifiers, lubricants, cleaning agents, such as for metal, rheological thickening agents, such as for aqueous solutions and drilling fluids.

The present disclosure provides embodiments wherein the composition may be a 100% biobased drilling fluid. In certain embodiments, the biobased drilling fluid comprises a hydrocolloid gum, a cellulose thickener, and a solvent component. The solvent component may be a solvent blend comprising the solvent constituents set forth herein, such as, for example, a blend of an alkylene glycol alkyl ether and a lactate ester. The biobased drilling fluid may be 100% biobased as determined by ASTM International Radioisotope Standard Method D 6866.

It had been found that bioderived products, such as hydrocolloid gums, including xanthan gum, offer an attractive alternative for industrial manufacturers looking to reduce or replace their reliance on petroleum derived products. As used herein, the term “bioderived” includes products that are derived from, or synthesized by, a renewable biological feedstock, such as, for example, an agricultural, forestry, plant, bacterial, or animal feedstock. The replacement of petroleum derived products with products derived from biological sources (i.e., biobased products, referring to those products that include, in whole or in significant part, biological products or renewable agricultural materials (including plant, animal and marine materials) or forestry materials) offer many advantages. For example, products from biological sources are typically a renewable resource. As the supply of easily extracted petrochemicals continues to be depleted, the economics of petrochemical production will likely force the cost of petrochemicals and petroleum derived products higher relative to biobased products. As used herein, the term “petroleum derived” includes a product derived or synthesized from petroleum or a petrochemical feedstock. In addition, companies may benefit from the marketing advantages associated with bioderived products, based, at least in part, on public support for alternatives to petrochemicals. Furthermore, biobased products may qualify for purchase requirements by federal agencies under FSRIA, while petroleum derived products do not.

Certain embodiments will be described further by reference to the following examples. The following examples are merely exemplary and are not intended to be limiting. Unless otherwise indicated, all parts are by weight.

### EXAMPLES

The following Examples describe xanthan gum slurry formulations.

### Example 1

Add 57.22 g ethyl lactate (commercially available from Archer Daniels Midland Company, Decatur, Ill.) to a 250 mL beaker. Using an overhead stirrer with 3-prong plastic propeller, mix solution at about 300 rpm and add 0.78 g HPC (hydroxypropylcellulose; Hercules Klucel type H Ind). Mix well for 2 to 4 hours to fully wet out HPC in ethyl lactate and increase mixer speed as needed to form a small vortex. Turn off mixer and cover beaker with foil and let beaker sit overnight for about 17 hours. Place the solution on the mixer again for 1 to 2 more hours. Take the beaker off the mixer. Hand mix in 42 g xanthan gum (OptiXan™, commercially available from Archer Daniels Midland Company, Decatur, Ill.) adding a small amount of xanthan gum at a time. Put slurry in air tight glass jar.

### Example 2

Add 28.63 g ethyl lactate (commercially available from Archer Daniels Midland Company, Decatur, Ill.) to 250 mL beaker. Using an overhead stirrer with 3 prong plastic propeller, mix solution at about 200 rpm. Add 28.63 g dipropylene glycol methyl ether (commercially available from Sigma-Aldrich, St. Louis, Mo.) to ethyl lactate in beaker and allow solvents to combine. Increase mixer speed to 300 rpm and add 0.74 g HPC (hydroxypropylcellulose; Hercules Klucel type H Ind). Mix for about 2 hours, increasing mixing speed to form a small vortex as needed. Turn off mixer, cover beaker and let it sit overnight for about 16 hours. Put solution on mixer for 1 to 2 hours. Remove beaker from mixer. Hand mix in 42.00 g xanthan gum (OptiXan™, commercially available from Archer Daniels Midland Company, Decatur, Ill.), adding a small amount of xanthan gum at a time. Store slurry in air tight glass jar.

While this invention has been particularly shown and described with references to exemplary embodiments thereof, it will be understood by those skilled in the art that various changes in form and details may be made therein without departing from the scope of the invention encompassed by the appended claims.

We claim:

1. A composition comprising:
a hydrocolloid gum;
a cellulose thickener; and
a solvent component comprising a lactate ester.

2. The composition of claim 1, the solvent component further comprising an alkylene glycol alkyl ether.

3. The composition of claim 2, wherein the alkylene glycol alkyl ether is selected from the group consisting of ethylene glycol monomethyl ether, ethylene glycol monomethyl ether acetate, ethylene glycol monoethyl ether, ethylene glycol monoethyl ether acetate, ethylene glycol monopropyl ether, ethylene glycol monobutyl ether, ethylene glycol dimethyl ether, ethylene glycol diethyl ether, diethylene glycol, diethylene glycol monomethyl ether, diethylene glycol Imonoethyl ether, diethylene glycol monobutyl ether, diethylene glycol dimethyl ether, diethylene glycol propyl ether, triethylene glycol dimethyl ether, propylene glycol monomethyl ether, propylene glycol monomethyl ether acetate, dipropylene glycol, and dipropylene glycol monomethyl ether and combinations of any thereof.

4. The composition of claim 1, wherein the lactate ester is selected from the group consisting of ethyl lactate, methyl lactate, butyl lactate, and combinations of any thereof.

5. The composition of claim 1, wherein the lactate ester is ethyl lactate.

6. The composition of claim 2, wherein the alkylene glycol alkyl ether comprises dipropylene glycol methyl ether.

7. The composition of claim 6, wherein the solvent component comprises from 0% to 95% of the alkylene glycol alkyl ether by weight and from 1% to 100% of the ethyl lactate by weight.

8. The composition of claim 4, wherein the solvent component further comprises diethylene glycol propyl ether.

9. The composition of claim 8, wherein the solvent component comprises from 0% to 95% diethylene glycol propyl ether by weight and from 1% to 100% ethyl lactate by weight.

10. The composition of claim 1, wherein the cellulose thickener is selected from the group consisting of hydroxypropyl cellulose, hydroxyethyl cellulose, hydroxypropylmethyl cellulose, ethyl hydroxyethyl cellulose, methyl ethyl hydroxyethyl cellulose, hydroxymethyl cellulose, hydroxyethylmethyl cellulose, carboxymethyl cellulose, sodium carboxymethyl cellulose, microcrystalline cellulose, and combinations of any thereof.

11. The composition of claim 1, wherein the hydrocolloid gum is selected from the group consisting of an xanthan gum, a guar gum, a gellan gum, locus bean gum, gum Arabic, alginates, and mixtures of any thereof.

12. The composition of claim 1, further comprising a compound selected from the group consisting of surfactants, dispersants, pH modifiers, defoamers, biocides, humectants, colorants, pigments, and combinations of any thereof.

13. The composition of claim 1, wherein the composition contains from 1 % to 45% of the hydrocolloid gum by weight.

14. The composition of claim 1, wherein less than 1% by weight of hydrocolloid gum particles settle out of the composition within a period of 12 months.

15. The composition of claim 1, wherein the solvent component comprises from 5% to 50% ethyl lactate and the composition has a flash point of 140° F. or higher.

16. A thickening system comprising the composition of claim 1.

17. The composition of claim 11, wherein the hydrocolloid gum is the xanthan gum and is selected from the group consisting of an unmodified xanthan gum, a modified xanthan gum, and mixtures of any thereof.

18. The composition of claim 1, wherein the composition is aqueous.

19-25. (canceled)

26. A drilling fluid comprising the composition of claim 1, wherein the drilling fluid is 100% biobased as determined by ASTM International Radioisotope Standard Method D 6866.

27. A composition comprising:
a thickening agent selected from the group consisting of a hydrocolloid gum, a starch, a cellulose thickener and combinations of any thereof; and
a biobased solvent as determined by ASTM International Radioisotope Standard Method D 6866.

28. The composition of claim 27, further comprising an alkylene glycol alkyl ether.

29. The composition of claim 27, wherein the hydrocolloid gum is xanthan gum and the cellulose thickener is hydroxypropylcellulose.
